(19) United States
(12) Patent Application Publication
(10) Pub. No.: US 2009/0029720 A1
(43) Pub. Date: Jan. 29, 2009

(54) SYSTEM AND METHOD FOR PROVIDING ELECTRONIC ADVERTISEMENTS

(75) Inventors: Christopher Jaffe, San Mateo, CA (US); Ronald Martinez, San Francisco, CA (US); Joseph O'Sullivan, Oakland, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/829,329

(22) Filed: Jul. 27, 2007

(51) Int. Cl. H04Q 7/20

(52) U.S. Cl. 455/456.3

(57) ABSTRACT

A system for displaying electronic advertisements on a display device includes a processor having a set of instructions, a display device in communication with the processor and a network interface in communication with the processor. The processor is configured by the set of instructions to receive an initial advertisement from a central server via the network interface, display an initial advertisement and a first navigational element on the display device, receive a subsequent advertisement from the central server based on a user's interaction with the initial advertisement, and display the subsequent advertisement on the display device when the first navigational element is selected by the user.

### BACKGROUND OF THE INVENTION

1. Field of the Invention

The invention relates to advertising and more specifically to Internet based advertising.

2. Description of the Known Technology

Electronic devices, such as personal computers, mobile phones, personal digital assistants, game consoles, interactive televisions or telematic devices are capable of assisting a user of the electronic device in numerous ways. Increasingly, this form of electronic assistance may originate in remote services, such as those commonly found on the Internet.

It is not uncommon that many of these remote services are provided at little or no cost to the user. The providers of these remote services are able to justify providing these services at little or no cost to the user because the service provider will incorporate advertisements within these remote services. The service provider will charge third party advertisers a fee for embedding these advertisements within the remote services.

In order to maximize the amount of revenue received from third party advertisers, remote service providers generally attempt to increase the number of advertisements in their remote services. However, electronic devices have a finite amount of display space, limiting the amount of space for available for advertising, negatively impacting the amount of revenue received from third party advertisers. This problem is exacerbated because there is a growing trend towards using mobile phones and personal digital assistants, which typically have relatively small display areas, further limiting the amount of advertisements the remote service provider can provide to the electronic device.

### BRIEF SUMMARY OF THE INVENTION

In overcoming the drawbacks of the prior art, a system and method for providing electronic advertisements on an electronic device are described. The electronic device includes a processor having a set of instructions, a display device in communication with the processor and a network interface in communication with the processor. The processor is configured by the set of instructions to receive an initial advertisement from a central server via the network interface, display an initial advertisement and a first navigational element on the display device, receive a subsequent advertisement from the central server based on a user's interaction with the initial advertisement, and display the subsequent advertisement on the display device when the first navigational element is selected by the user.

The system for providing electronic advertisements to a display device of the electronic device includes a processor having a set of instructions and a network interface in communication with the processor, the network interface configured to place the system in communication with the remote device. The processor of the system for providing electronic advertisements is configured by the set of instructions to transmit an initial advertisement and a navigational element to the remote device, receive a first navigational signal from the remote device, the navigational signal being transmitted when the navigational element is selected by the user of the remote device, select a subsequent advertisement based on the user's interaction with the initial advertisement, and transmit the subsequent advertisement after the navigational signal is received.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1A is a block diagram of a system for providing electronic advertisements;

FIG. 1B is a block diagram of the central server shown in FIG. 1A;

FIG. 1C is a block diagram of the remote device shown in FIG. 1A;

FIG. 2 is a screen capture of a display device of a remote device displaying an electronic advertisement;

FIG. 3 is a screen capture of a display device of a remote device displaying an electronic advertisement with a preview window; and

FIG. 4 is a screen capture of a display device of a remote device displaying another embodiment of the electronic advertisement with a preview window.

### DETAILED DESCRIPTION OF THE INVENTION

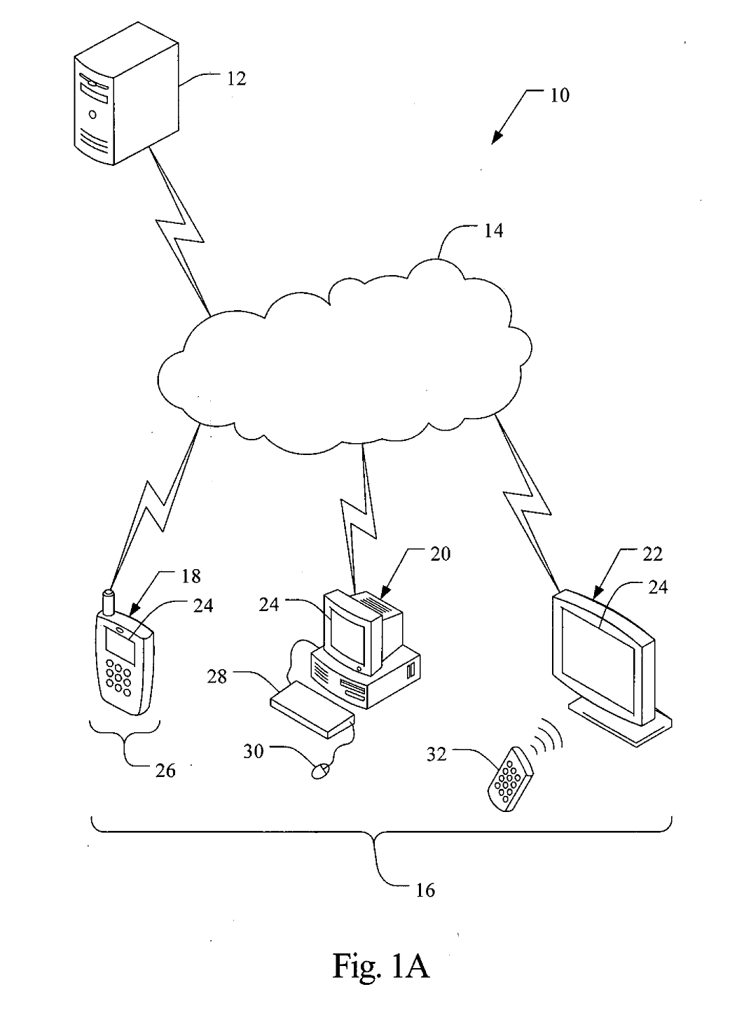

Referring to FIGS. 1A-1C, a system 10 includes a central server 12, a network 14, and a remote device 16. The central server 12 generally includes a processor 23 and a network interface capable 27 of placing the central server 12 in communication with the network 14. The central server 12 may also include one or more storage devices 27 for storing information to be transmitted to the remote device 16 via the network 14. The network 14 may be a local area network, a wide area network or distributed network, such as the Internet.

The remote device 16 may be any one of a number of different devices capable of interfacing with the network 14. As shown in FIG. 1, the remote device 16 may be a mobile device 18, such as a mobile phone or a personal digital assistant, a general purpose personal computer 20, or may be an Internet protocol television 22. Regardless of which type of remote device 16 is utilized, the remote device 16 will include, as shown in a simplified block diagram of FIG. 1C, a processor 17, a network interface 19 for interfacing the processor 17 of the remote device 16 with the network 14, a display device 24 and an input device. Instructions to configure the processor 17 may be stored within the processor 17 or in a separate memory storage device 21. The input device may take the form as a keypad 26, such as in the case of the mobile device 18. If the remote device 18 is a general purpose personal computer 20, the input device may be in the form of a keyboard 28 and/or a mouse 30. If the remote device is an Internet protocol television, the input device may be a remote control 32. Of course, it should be understood that any one of a number of devices may be utilized as the input device of the remote device 16. For example, the mobile device 18 or Internet protocol television 22 may be in communication with a mouse or keyboard. Similarly, the general purpose personal computer 20 may be in communication with a remote control or a separate keypad.

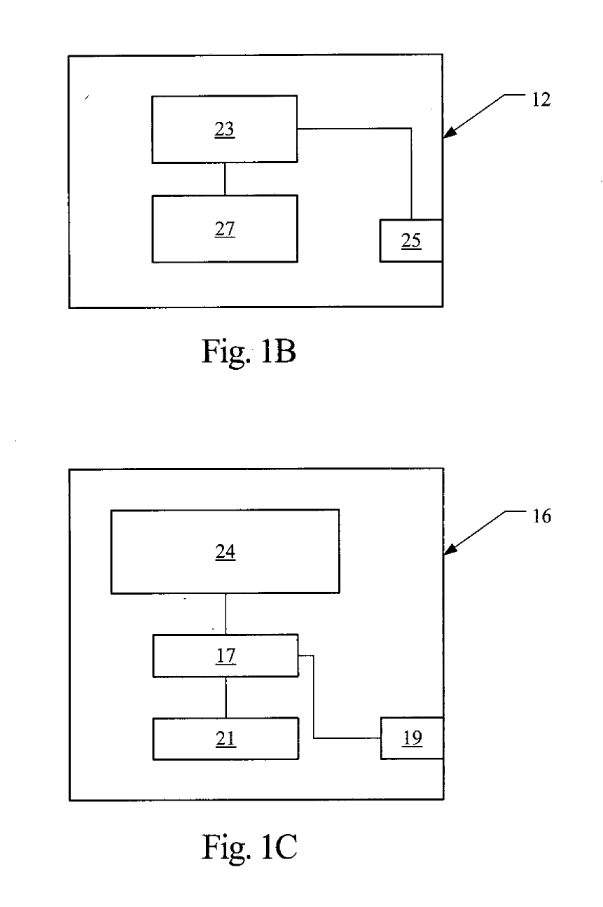

Referring to FIG. 2, a more detailed view of the display 24 of the remote device 16 is shown. As stated previously, the remote device 16 includes a processor having a set of instructions. The processor 17 is configured by the set of instructions to receive an initial advertisement from the central server 12. The initial advertisement generally includes data and additional instructions which cause the processor to display a predetermined advertisement. The initial advertisement is received from the central server using the network interface. The processor 17 then displays the initial advertisement 34 in the display device 24. The initial advertisement 24 may be a static media advertisement, sequential media advertisement or combination thereof. The static media advertisement may be text and/or still graphics, while the sequential media advertisement may include audio and video.

The processor 17 of the remote device 16 is also configured to receive a first and second navigational element from the central server 12 via the network 14. The first and second navigational elements 36, 38 are displayed on the display device 24, generally being positioned just outside the initial advertisement 34, so as to not interfere with the viewing of the initial advertisement 34. Although this embodiment includes two navigational elements 36, 38, it should be understood that any number of navigational elements, or even a single navigational element, may be utilized.

The navigational elements 36, 38 in the illustrated example include two buttons which are displayed on a touch sensitive or other screen. The data and instructions received with the initial advertisement define position, appearance and effect of actuating the buttons 36, 38. For example, the buttons may be actuated by clicking with a mouse or tapping with a finger or stylus on a touch sensitive screen. The effect of the actuation, including displaying additional information, is defined by the data and instructions of the initial advertisement receive by the device.

When the first navigational element 36 is selected by the remote device 16 via one of the input devices such as the keypad 26, keyboard 28, mouse 30 or remote control 32, the initial advertisement 34 will be replaced with a subsequent advertisement 40. If the user wishes to return to the initial advertisement 36, the user can select the second navigational element 38 to return to the initial advertisement 34. By allowing users of the mobile device 16 to rotate through advertisements using the navigational elements 36, 38, numerous electronic advertisements can be provided to the user of the remote device 16, even if the remote device 16 has a very small display device or if a small portion of the display device 24 is allotted for displaying electronic advertisements.

In the embodiment shown in FIG. 2, the subsequent advertisement 40 is shown in an angled form so as to provide the user with a preview of the subsequent advertisement 40. When the first navigational element 36 is selected, the subsequent advertisement 42 takes the place of the initial advertisement 34. Additionally, FIG. 2 also shows an angled display of a prior advertisement 42. When the first navigational element 36 is selected, initial advertisement 34 will take the place of the prior advertisement 42 in an angled fashion. Of course, it should be understood that any one of a number of ways of showing a preview of the prior advertisement 42 and/or subsequent advertisement 44 may be utilized. Additionally, it should be understood that no preview of the review of the prior advertisement 42 and/or subsequent advertisement 44 may be displayed.

The central server 12 monitors the user's interaction with the initial advertisement 34 so as to better select subsequent advertisements 40 that will induce the user to select the subsequent advertisement 40. This is important because many remote service providers, such as Yahoo! Inc. of Sunnyvale, Calif., receive additional revenues if the user selects the advertisement.

There are different methodologies that may be utilized to better target the user. These methodologies may be used individually or in concert with each other. One methodology is a pattern recognition methodology. The pattern recognition methodology takes note of which advertisements catch the interest of the user. This can be accomplished noting the user's interaction with the initial advertisement 34. The user's interaction with the initial advertisement 34 may include determining an amount of time the initial advertisement 34 was displayed on the display device 24. If, for example, the user spends a significant period of time looking at an advertisement, this may indicate that the user is interested in the subject matter of that advertisement. If a determination is made that the user is interested in that subject, subsequent advertisements will be selected that are of the same subject matter.

Another was of determining if the subject matter of the initial advertisement 34 is of an interest to the user, is by noting if the user selected the initial advertisement 34 or the navigational element 36. Essentially, the selection of the initial advertisement 34 is interpreted as a “yes” to the question of if the subject matter of the initial advertisement 34 is of an interest to the user. Conversely, a selection of the navigational element 36 by the user is seen as a “no” to the same question. By tracking which initial advertisements 34 induce a user selection, and thereby be of an interest to the user, subsequent advertisements can be selected that are of an interest to the user.

A third methodology that may be utilized is using the users past experiences as a factor. This may be accomplished by monitoring the user's interaction and creating a profile of the user. For example, if the profile of the user indicates that the user has recently performed several Internet searches relating to athletic shoes, subsequent advertisements may be selected relating to athletic shoes.

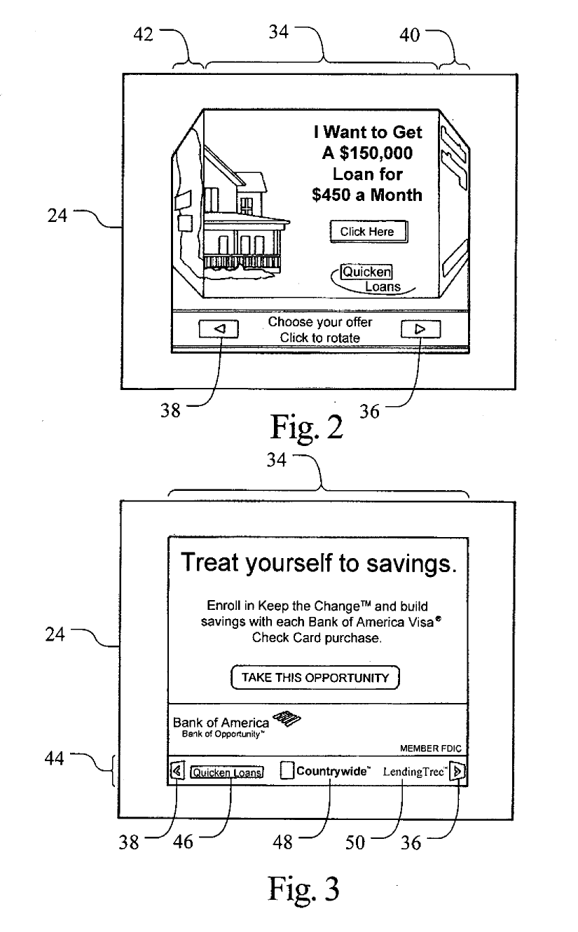

Referring to FIG. 3, another embodiment is shown. Here, the initial advertisement 34 is displayed as before; however, the subsequent advertisement 40 and the previous advertisement 42 are not shown. Additionally, there is a preview window 44 located beneath the initial advertisement 34. The first and second navigational elements 36, 38 are located within the preview window 44. Previews of advertisements 46, 48, 50 are displayed in the preview window 44. If the user selects any of the preview advertisements 46, 48, 50, the advertisement selected will then be displayed where the initial advertisement 34 is displayed. Selecting the first and second navigational elements 36, 38 scrolls previews of advertisements through the preview window 44. When the user sees an advertisement they would like to know more about, the user simply selects the preview advertisement and the preview advertisement is displayed where the initial advertisement 34 is displayed.

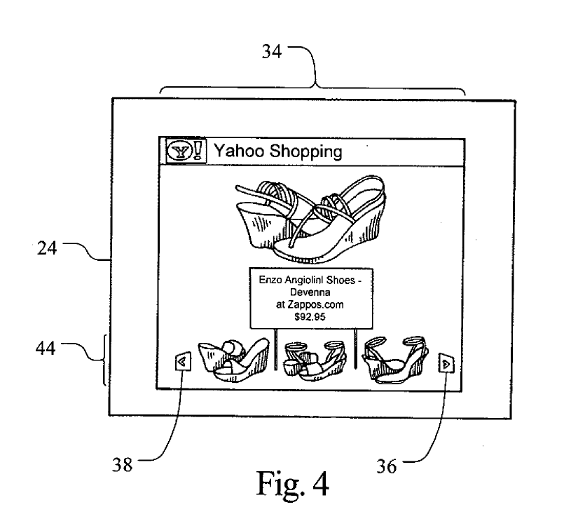

Referring to FIG. 4, another embodiment is shown. Here, the initial advertisement 34 is shown similarly to the embodiment in FIG. 3. Also, similar to FIG. 3, navigational elements 36, 38 are displayed in the preview window 44. Here, for example, women's shoes are shown in both the initial advertisement 34 and the preview window 44. Scrolling through the preview window will display other product choices during the presentation of the initial advertisement 34.

As described ion the previous paragraphs, any one pf a number of methodologies can be used to select subsequent advertisements based on the interaction of the user with the initial advertisements. However, when utilizing the preview window 44, additional functionality can be incorporated. For example, if the user selects one of the preview advertisements 46, 48, 50, the preview advertisement selected will be displayed where the intial advertisement 34 was displayed. Additionally, the advertisements displayed in the preview window 44 may be updated so as to account for the user's previous selection of the preview advertisement. For example, assume that the preview window 44 displays three types of automobiles. The first automobile is a sport utility vehicle, the second is a sedan and the third is a coupe. If the user selects the coupe from the preview window 44, the coupe will be displayed where the initial advertisement was previously displayed. Additionally, the preview window 44 could be updated to now include similar types of vehicles, in this case, coupes.

Turning our attention to the central server 12, the following paragraphs will describe the hardware and software of the central server 12. The processor 23 of the central server 12 is configured by the set of instructions 27 to transmit an initial advertisement and at least one navigational element to the remote device 16. When the user of the remote device 16 selects the navigational element, a navigational signal is sent from the remote device 16 to the central server 12. Thereafter, the central server 12 selects a subsequent advertisement based on the user's interaction with the initial advertisement, and transmits the subsequent advertisement to he remote device 16. As stated previously, the initial and subsequent advertisements may be a static media advertisement or may be a sequential media advertisement.

Also, as stated previously, the processor 23 of the central server 12 is configured to transmit a preview window to the remote device 16, wherein the preview window contains information relating to previews of additional subsequent advertisements. Furthermore, if one of the subsequent advertisements displayed in the preview window is selected by the user of the remote device 16, the central server will transmit the selected subsequent advertisement to the remote device.

The central server 12 makes a determination as to which subsequent advertisements the user is most likely to be interested in. To make this determination, the central server 12 will look at a variety of different variables in making its determination, such as those described in the previous paragraphs. Some examples include monitoring the user's interaction with the initial advertisement. This can include determining the amount of time the initial advertisement was displayed on the display device and/or includes a determination if the user selects the initial advertisement. Additionally, the central server 12 may be configured to receive information relating to the user's interaction with the initial advertisement and generate a user profile based on the information relating to the users interaction with the initial advertisement. Thereafter, the central server 12 will use the user generated profile to select subsequent advertisements.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for displaying electronic advertisements on a display device, the method comprising the steps of:
displaying an initial advertisement on the display device;
displaying a first navigational element on the display device;
selecting a subsequent advertisement based on a user's interaction with the initial advertisement; and
displaying the subsequent advertisement on the display device when the first navigational element is selected by the user.

2. The method of claim 1, wherein the initial and subsequent advertisements are at least one of a static media advertisement or a sequential media advertisement.

3. The method of claim 1, further comprising the steps of:
displaying a second navigational element on the display device; and
displaying the initial advertisement on the display device when the second navigational element is selected by the user.

4. The method of claim 1, further comprising the steps of:
displaying a preview window on the display device, wherein the preview window displays previews of at least one additional subsequent advertisement; and
displaying the at least one additional subsequent advertisement when the preview of the at least one additional subsequent advertisement is selected by the user.

5. (canceled)

6. The method of claim 1, wherein the user's interaction with the initial advertisement includes an amount of time the initial advertisement was displayed on the display device.

7. The method of claim 1, wherein the user's interaction with the initial advertisement includes a determination if the user selected the initial advertisement.

8. The method of claim 1, further comprising the steps of;
transmitting information relating to the user's interaction with the initial advertisement to a central server, the central server being configured to generate a user profile based on the information relating to the user's interaction with the initial advertisement; and
selecting the subsequent advertisement based on the user profile.

9. (canceled)

10. A system for displaying electronic advertisements on a display device, the system comprising:
a processor having a set of instructions;
a display device in communication with the processor;
a network interface in communication with the processor;
the processor being configured by the set of instructions to receive an initial advertisement from a central server via the network interface, display an initial advertisement and a first navigational element on the display device, receive a subsequent advertisement from the central server based on a user's interaction with the initial advertisement, and display the subsequent advertisement on the display device when the first navigational element is selected by the user.

11. The system of claim 10, wherein the initial and subsequent advertisements are at least one of a static media advertisement or a sequential media advertisement.

12. The system of claim 10, wherein the processor is further configured by the set of instructions to display a second navigational element on the display device, and display the initial advertisement on the display device when the second navigational element on the display device is selected by the user.

13. The method of claim 10, wherein the processor is further configured by the set of instructions to display a preview window on the display device, wherein the preview window displays previews of at least one additional subsequent advertisement, and display the at least one additional subsequent advertisement when the preview of the at least one additional subsequent advertisement is selected by the user.

14. (canceled)

15. The system of claim 10, wherein the user's interaction with the initial advertisement includes an amount of time the initial advertisement was displayed on the display device.

16. The system of claim 10, wherein the user's interaction with the initial advertisement includes a determination if the user selected the initial advertisement on the display device.

17. The system of claim 10, wherein the processor is further configured by the set of instructions to transmit information relating to the user's interaction with the initial advertisement to the central server via the network interface, the central server being configured to generate a user profile based on the information relating to the user's interaction with the initial advertisement.

18. A method for providing electronic advertisements on a display device of a remote device of a user, the method comprising:
transmitting an initial advertisement and a navigational element to the remote device;
receiving a navigational signal from the remote device, the navigational signal being transmitted when the navigational element is selected by the user of the remote device;
selecting a subsequent advertisement based on the user's interaction with the initial advertisement;
transmitting the subsequent advertisement after the first navigational signal is received; and
wherein the initial and subsequent advertisements are at least one of a static media advertisement or a sequential media advertisement.

19. (canceled)

20. The method of claim 18, further comprising the steps of:
transmitting a preview window to the remote device, wherein the preview window contains information relating to previews of at least one additional subsequent advertisement; and
transmitting the at least one additional subsequent advertisement to the remote device when the preview of the at least one additional subsequent advertisement is selected by the user of the remote device.

21. (canceled)

22. The method of claim 18, wherein the user's interaction with the initial advertisement includes an amount of time the initial advertisement was displayed on the display device.

23. The method of claim 18, wherein the user's interaction with the initial advertisement includes a determination if the user selected the initial advertisement on the display device.

24. The method of claim 18, further comprising the steps of:
receiving information relating to the user's interaction with the initial advertisement;
generating a user profile based on the information relating to the user's interaction with the initial advertisement; and
selecting the subsequent advertisement based on the user profile.

25. (canceled)

26. A system for providing electronic advertisements to a display device of a remote device of a user, the system comprising:
a processor having a set of instructions;
a network interface in communication with the processor, the network interface configured to place the system in communication with the remote device; and
the processor being configured by the set of instructions to transmit an initial advertisement and a navigational element to the remote device, receive a first navigational signal from the remote device, the navigational signal being transmitted when the navigational element is selected by the user of the remote device, select a subsequent advertisement based on the user's interaction with the initial advertisement, transmit the subsequent advertisement after the navigational signal is received, and wherein the initial and subsequent advertisements are at least one of a static media advertisement or a sequential media advertisement.

27. (canceled)

28. The system of claim 26, wherein the processor is further configured by the set of instructions to transmit a preview window to the remote device, wherein the preview window contains information relating to previews of at least one additional subsequent advertisement.

29. The system of claim 28, wherein the processor is further configured by the set of instructions to transmit the at least one additional subsequent advertisement to the remote device when the preview of the at least one additional subsequent advertisement is selected by the user.

30. The system of claim 26, wherein the user's interaction with the initial advertisement includes an amount of time the initial advertisement was displayed on the display device.

31. The system of claim 26, wherein the user's interaction with the initial advertisement includes a determination if the user selected the initial advertisement.

32. The system of claim 26, wherein the processor is further configured by the set of instructions to receive information relating to the user's interaction with the initial advertisement, generate a user profile based on the information relating to the user's interaction with the initial advertisement, and select the subsequent advertisement based on the user profile.

33. (canceled)
